(19) United States
(12) Patent Application Publication
(10) Pub. No.: US 2013/0172791 A1
(43) Pub. Date: Jul. 4, 2013

(54) Method for vibrator for sexual proposes

(71) Applicant: Shoham Golan, Natanya (IL)

(72) Inventor: Shoham Golan, Natanya (IL)

(21) Appl. No.: 13/341,966

(22) Filed: Dec. 31, 2011

(51) Int. Cl. A61H 19/00

(52) U.S. Cl. 601/46; 606/38

(57) ABSTRACT

A method for a sexual stimulation aid such as a vibrator with at list one sensor connecting to a computerized or electronic operator, wherein, the sensors designated to imitates male pin physiologic behaviors, wherein, one implementation of the method enabling by an appropriate sensors, connected to the vibrator mechanism, fitted to detect wetness, or moistness, or touch, or combination of some of these sensors, wherein, when the sensor detecting the condition, the reading passes to the vibrator mechanism that change the vibrator position from “fallen condition” to “stand still condition” as in the method of the present invention. A strap extension to the vibration unit is optional in the method scope of the present invention.

### BACKGROUND OF THE INVENTION

The present invention relates methods used for sexual pleasure, and more particularly, relating to sensors combined in a vibrator system and mechanism designated to mimic the human pin physiological behaviors.

There is a growing acceptance of sexuality, as exhibited by popular acceptance of the near-universality of masturbation, and the growth of the market for sexual devices. Prior to this shift there have been a plethora of devices sold for sexual pleasure, although primarily under the euphemistic names and a pretense of providing “massage”. Modern sexual devices fall broadly into two classes: mechanized and no mechanized. Mechanized devices typically vibrate, although there are examples that rotate, thrust, and even circulate small beads within an elastomeric shell. Non-mechanized devices are made from a solid mass of rigid or semi-rigid material in a variety of shapes.

Although not spoken of openly in Western society until recently, oral sex is accorded a revered place in many cultures. Oral sex is the act of using the mouth, lips, and tongue to stimulate the female genitals. Oral sex is often accompanied by the insertion of fingers or a sexual aid into the vagina and/or into the anus, which allows for the simultaneous stimulation of the recipients sexual pleasure zones, which many women find can produce very intense sensations.

What is desirable is a method which can be performed in vibrator devices and systems, and which will enables the vibrator to imitates the male pin physiologic behaviors when corn in contact with the female sexual area.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

A method designated for a sexual stimulation aid, such as for a vibrator, wherein, the method enables the vibrator by its system and mechanism, enabling to mimic the human male physiologic reaction of the male pin when coming in contact with the female sexual organ.

wherein, the method enabled by using at list one sensor connecting to a computerized or electronic system operating the vibrator systems, wherein, the sensors designated to imitates male pin physiologic behaviors, wherein, implementations of the method enabled by an appropriate sensors, connected to the vibrator system operation mechanism, fitted to detect wetness, or moistness, or touch, or some combination of some of these sensors, and, when the sensors detecting the female signs and condition, such as the wetness of the inner female sexual organism, wherein, the analysis data are sending the signal from the sensors to the vibrator mechanism, and that changing the vibrator position from “fallen condition” to “stand still condition” that enlarge the vibrator size, as in the method of the present invention.

### DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

The present invention is in method, designated for a sexual stimulation aid, such as for a vibrator, wherein, the method enables the vibrator by its system and mechanism, to mimic the human male physiologic reaction of the male pin when coming in contact with the female sexual organ, wherein, in that meeting, the mal pin is growing in its size to a bigger size then in a non-stimulation condition.

wherein, the method enables by using at list one sensor at the vibrator upper surface, and the sensor is connecting to a “on/off” switch, that operates the system and mechanism in the hollows inner part of the vibrator device, a mechanism that has at list two states, one, in the default position, and the second, that changes by the sensor detection and operation system, is the one growing in its size to a bigger size then in a non-stimulation condition, enabling the outer surface of the vibrator which is with a characteristic that enabled to stretches to a bigger and larges size, to mimic the human mal pin as in the present invention method.

wherein, in one implementation of the present invention, the sensors are connected to an electricity source of power, such as to an electric battery, and when the sensors detecting for example wetness, they sending signal to another operator that operates the vibrator system and mechanism from its default condition, a “fallen condition” which the vibrator is not strained to its optimum bigger size, to its “stand still condition”, which is a strained position of the vibrator. Wherein, various implementation known to the one skilled in the art, and are in the wisdom of prior-art, are appropriate to enables the method of the present invention by the system and mechanism of the vibrator. A mechanical mechanism operated by electric engine can expend or narrow parts of the system that may be in the inner hollows parts of the vibrator, and as long as the vibrator surface made out of a starching materials, the object of the present invention method is possible. Further implementation, enabling the method of the present invention, such as for example, an air blowing mechanism, or a telescopic parts in the inner hollowed parts of the vibrator that have at list two size, one bigger and on smaller from each other, wherein, the bigger sized condition is the state of the system mechanism due to the sensors detecting signal that operates the mechanism to mimic the male pin at a stimulate condition, and more.

A computerized or electronic operator is available and possible in the vibrator systems. wherein, the sensors designated to imitates male pin physiologic behaviors, wherein, implementations of the method enabled by an appropriate sensors, connected to the vibrator mechanism, fitted to detect wetness, or moistness, or touch, or some combination of some of these sensors, and, when the sensors detecting the female signs and condition, such as the wetness of the inner female sexual organ, an analysis data sending signal from the sensors to the vibrator mechanism, and that changing the vibrator position from “fallen condition” to “stand still condition” as in the method of the present invention.

The present invention is not intended to be limited to the 5 specifications described above, but rather, encompass all the manifestations within the scope of the following claims.

1. A method for a vibrator device used for sexual stimulation, wherein, the method comprising:
a. A vibrator designated for a sexual stimulation aid, wherein, the vibrator by its system and mechanism, designated to mimic the human male physiologic reaction of the male sexual pin when coming in contact with the female sexual organ, and stimulates, and as a results of this grow in size to a bigger size then in a non-stimulation condition, wherein;
b. wherein, the method enables by using at list one sensor at the vibrator upper surface, wherein;
c. the sensor is connecting to a “on/off” switch, that operates the power source of a system and mechanism in the hollows inner part of the vibrator device, wherein;
d. the mechanism has at list two states, one, in the default position, and the second, that changes by the sensor detection and operation “on” switch, when detecting a stimulating condition, wherein;
e. Operating the system and mechanism, enabling the outer surface of the vibrator which is with a characteristic that enables it to stretches to a bigger and larges size, to mimic the human male sexual pin, as in the present invention method.

2. Method as claimed in claim 1, wherein, in one implementation of the present invention, the sensors are connected to an electricity source of power, such as to an electric battery, and when the sensors detecting for example wetness, they sending signal to another “one” switch that closing an electric circuit that operates the vibrator system and mechanism, from its default condition, of a “fallen condition” which the vibrator is not strained to its optimum bigger size, to its “stand still condition”, which is a strained position of the vibrator.

3. Method as claimed in claim 1, wherein, various implementations enabled by known technology in the prior-art, and those are appropriate to enables the method of the present invention by a system and mechanism enabled by those technology in the vibrator of the present invention: a. a mechanical mechanism operated by electric engine can expend or narrow parts of the system that may be in the inner hollows parts of the vibrator as in the method of the present invention, and as long as the vibrator surface made out of a starching materials, the object of the present invention method is possible; b. Further implementation, enabling the method of the present invention, such as for example, an air blowing mechanism; c. Further implementation, enabling the method of the present invention, such as for example, a telescopic parts in the inner hollowed parts of the vibrator that have at list two size, one bigger and on smaller from each other, wherein, the bigger sized condition is the state of the system mechanism due to the sensors detecting signal that operates the mechanism telescopic inner parts, to mimic the male sexual pin, as in a stimulate condition.

4. Method as claimed in claim 1, wherein, a computerized or electronic operator is available and possible in the vibrator systems. wherein, the sensors designated to imitates male pin physiologic behaviors, wherein, implementations of the method enabled by an appropriate sensors, connected to the vibrator mechanism, fitted to detect wetness, or moistness, or touch, or some combination of some of these sensors, and when the sensors detecting the female signs and condition, such as the wetness of the inner female sexual organ, an analysis data sending signal from the sensors to the vibrator mechanism, and that begin to operate and changing the vibrator position from “fallen condition” to “stand still condition” as in the method of the present invention.

5. Method as claimed in claim 1, wherein, at a stimulates condition detected by the sensors, and at a time of operating the mechanism of the vibrator to its bigger size, a mechanism that wetting the outer surface of the vibrator is activated.
